(19) United States
(12) Patent Application Publication
(10) Pub. No.: US 2005/0115761 A1
(43) Pub. Date: Jun. 2, 2005

(54) Device for the wireless transmission of electrical signals from a vehicle steering wheel

(75) Inventors: Subimal Dinda, W. Bloomfield, MI (US); Thomas Moore, Oxford, MI (US); Robert Newberry, Filderstadt (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/902,258

(22) Filed: Jul. 30, 2004

(30) Foreign Application Priority Data
Sep. 18, 2003 (DE) 103 43 147.0

(51) Int. Cl. B62D 5/00

(52) U.S. Cl. 180/402

(57) ABSTRACT

In a device for wireless transmission of electrical signals between the steering wheel of a vehicle and the chassis of the vehicle, a first transmission module, which includes a microcontroller and a transmitter for electromagnetic waves, is provided on the steering wheel. The microcontroller is designed to condition and convert electrical signals of operator control elements, arranged on the steering wheel, into signals which are suitable for the transmitter module. A second transmission module which includes a receiver and a microcontroller is arranged on a fixed region or chassis of the vehicle. The latter microcontroller is designed to convert signals which are received in the receiver into switching and/or control signals for electrical devices of the vehicle.

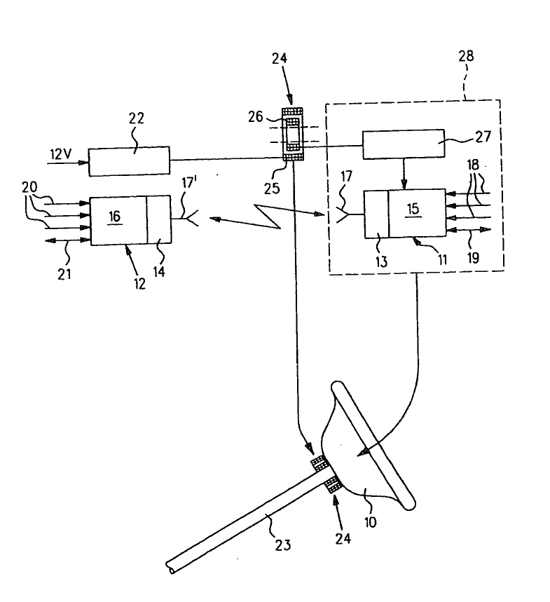

### BACKGROUND AND SUMMARY OF THE INVENTION

This application claims the priority of German patent document 103 43 147.0, filed 18 Sep. 2003, the disclosure of which is expressly incorporated by reference herein.

The invention relates to a device for wireless transmission of electrical signals between the movable region of the steering wheel of a vehicle and a region of the vehicle which is fixed with respect to the steering wheel. In known devices of this type, a first transmission module is arranged on the moved region of the steering wheel, and a second transmission module, which is provided with a receiver module and a microcontroller, is arranged on the fixed region of the vehicle. The microcontroller is designed to convert the signals received in the receiver module into switching and/or control signals for electrical devices of the vehicle. The transmission frequency between the transmission modules is in the gigahertz range.

German patent document DE 4101163 C1 discloses a device for contactless transmission of instruction signals from the steering wheel to the chassis of a motor vehicle, via a light transmission using a plurality of electrical light transmitters and receivers. This type of transmission has the disadvantage that line of sight contact must be maintained between the transmitters and receivers, so that the selection of the spatial arrangement is highly restricted. Furthermore, a certain degree of optical alignment is necessary, which makes the transmission system and its design expensive and complicated.

Furthermore, German patent documents DE 3812631 C1 and DE 3905422 A1 disclose a system for wirelessly interrogating the status of the electrical switching or triggering means in a motor vehicle by means of a rotary transformer, one of whose windings is arranged on the chassis, and whose other winding is arranged on the rotatable region from which signals are to be interrogated. However, the transmission of data via a rotary transformer is very slow, and is thus unsuitable for a large number of applications which require high speed data transmission.

In addition it has been known for some time to transmit the horn momentary-contact switch signal on the steering wheel by means of helical springs and/or slider contacts to the fixed region of the chassis. However, due to corrosion and soiling, this technique leads to faulty transmission in the case of high-speed serial data, which can constitute a safety problem, depending on the application.

German patent document DE 195 32 043 A1 discloses a steering wheel for a motor vehicle to which inductive energy and signals are to be transmitted. A description is given of an arrangement composed of coils on printed circuit boards, and its shaping process, in order to obtain a space-saving transmission device.

German patent document DE 101 28 045 A1 discloses a radio transmission system which transmits signals wirelessly between steering wheel momentary-contact switches and an evaluation unit in the motor vehicle, using the Bluetooth standard. However, only data signals from the steering wheel momentary-contact switches can be transmitted by means of Bluetooth transmission. The voltage must continue to be supplied by means of a wire connection to the Bluetooth receiver in the steering wheel. According to the object, the expenditure of lines is reasonably reduced.

Finally, European patent document EP 087 138 A1 describes how two concentric coils can be used to transmit alternating current wirelessly in a steering wheel. However, this method of transmission is disadvantageous for transmission of high speed and complex control signals.

One object of the invention is therefore to provide apparatus for high speed, wireless transmission of the generic type mentioned above, which permits a variable spatial arrangement, even over relatively large distances within the motor vehicle (in which case there is a high degree of susceptibility to faults), and also wirelessly provides the power supply for the wireless receiver itself.

This and other objects and advantages are achieved by the transmission apparatus according to the invention, in which the first transmission module is provided with a microcontroller and a transmitter module for electromagnetic waves. The microcontroller is designed to condition and convert the electrical signals of switching and/or control elements which are arranged on the steering wheel into signals which are suitable for the transmitter module. To supply power to the first transmission module, an inductive transformer with downstream rectifier arrangement is also provided on the steering wheel. The inductive transformer has a first, fixed, annular winding and a second, concentric annular winding which can rotate with the steering wheel. An alternating voltage or clock frequency generator which is operated by direct current is connected upstream of the inductive transformer.

In the apparatus according to the invention, the second transmission module, to which signals are to be transmitted from the steering wheel, can be arranged at virtually any desired location on the chassis since neither a line-of-sight link nor spatial proximity are necessary for the transmission. The data can be transmitted quickly and reliably so that, for example, triggering signals for the airbag or the like can also be transmitted. The two transmission modules can be very compact, which benefits the variable spatial arrangement. It is also possible to transmit a large number of different items of data without changing the configuration.

The transmitter module and the receiver module are each expediently embodied as bidirectional transmitter receivers in order to be able to transmit data both to and from the steering wheel.

In one particularly advantageous embodiment, the transmitter module and the receiver module are embodied as Bluetooth modules. They are suitable in particular for very rapid, serial transmission of data and are commercially available as finished modules. The transmission frequencies are preferably in the gigahertz range.

Particularly flexible application is achieved by providing the modules with bidirectional serial interfaces, in particular RS-232 interfaces.

Given the relatively large amount of power which is necessary, the power supply of the first transmission module in the steering wheel is suitably an inductive transformer which is arranged on the steering wheel and has the rectifier arrangement connected downstream. This inductive transformer expediently has a first fixed annular winding, and a second concentric, annular winding which can rotate with the steering wheel. In order to convert the direct voltage of the vehicle's onboard electrical system, an alternating voltage or frequency transformer is connected upstream of the inductive transformer. When a relatively small amount of supply power is necessary, the rectifier arrangement which converts the received radio frequency energy partially and/or temporarily into a supply of direct voltage (and downstream of which a storage device, in particular a capacitor or accumulator battery, is connected) is suitable for supplying power to the first transmission module in the steering wheel.

Other objects, advantages and novel features of the present invention will become apparent from the following detailed description of the invention when considered in conjunction with the accompanying drawings.

### BRIEF DESCRIPTION OF THE DRAWINGS

The single figure is a schematic illustration of a wireless transmission device for transmitting signals to and from a vehicle steering wheel.

### DETAILED DESCRIPTION OF THE DRAWINGS

Referring to the Figure, a first transmission module 11, which is illustrated in an enlarged form for the sake of clarity, is arranged in the steering wheel 10 of a motor vehicle (not shown). A second transmission module 12 is arranged on a region of the motor vehicle which is fixed, compared with the rotatable steering wheel 10. The two transmission modules 11, 12 each have a transmitter/receiver module 13, 14, a microcontroller 15, 16 and a transmitter/receiver antenna 17, 17′.

In a preferred embodiment, the transmitter/receiver modules 13, 14 are embodied as Bluetooth modules, and are designed to transmit data and/or electrical signals by the radio by means of electromagnetic waves in the gigahertz range. The data transmission rate for serial data is, for example, 700 kbit/sec.

Instead of transmitter/receiver modules 13, 14, it is also possible, in the simplest case, to provide only one transmitter module in the steering wheel and one receiver module which is permanently mounted outside the steering wheel, if data is to be transmitted only from (not to) the steering wheel.

The microcontroller 15 in the steering wheel is connected to a plurality of operator control elements 18 on the steering wheel, for example switches or momentary-contact switches for operating the radio, the speed monitoring unit, the horn, the on-board computer, the telephone and the like. Furthermore, a serial RS-232 interface 19 is provided for transmitting other serial data.

The data which comes from the operator control elements 18 and the interface 19 is conditioned in the microcontroller 13, encoded according to requirements and fed to the transmitter/receiver module, where serial data packets are generated, for transmission via transmitter/receiver module 13. The serial data received via the interface 19 are converted into a special serial protocol and transmitted in this form.

The data emitted by the transmitter/receiver module 13 in the steering wheel 10 are received in the transmitter/receiver module 14 and fed to the microcontroller 16. There, they are decoded and converted into switching signals or control signals which are then fed either to a central vehicle control electronic system or to directly corresponding electrical actuators for other electrical devices which are assigned to the operator control elements. For this purpose, the second transmission module 12 has corresponding output 20 and a RS-232 interface 21.

In order to supply voltage to the first transmission module 11 in the steering wheel 10, the voltage of the vehicle's onboard electrical system (usually 12 V) is fed to a clocked or frequency generator 22, for conversion into a clock voltage or an alternating voltage. The latter is fed to a ring-type transformer 24 which is arranged on the steering column 23 of the steering wheel 10. The latter has a fixed primary winding 25 which is embodied as an annular winding, and a concentric secondary winding 26 which is secured to the steering column 23 and whose induced voltage is fed to a rectifier arrangement 27 in the steering wheel 10. The rectifier arrangement 27 forms here, together with the first transmission module 11, a steering wheel electronic system 28 which may be of compact design, for example on a common printed circuit board. The rectified voltage of the rectifier arrangement 27 is used as a supply voltage for the first transmission module 11. For this purpose, the rectifier arrangement 27 can also have a voltage control or voltage stabilization means for generating the necessary direct voltage of usually 5 V.

In contrast to the illustrated example, a significantly simpler voltage supply for the first transmission module 11 may also be provided, in particular for the case in which the first transmission module 11 requires only very small quantities of supply power. In this case, the clocked generator or frequency generator 22, the ring-type transformer 24 and the rectifier arrangement 27 can be dispensed with. Part of the transmission energy which is transmitted by the second transmission module 12 and received in the transmitter/receiver module 13 of the first transmission module 11 can be rectified in the first transmission module 11 and fed to a storage device, for example a capacitor or a battery, which is then used as the voltage supply source. In this context it is possible, for example, to transmit energy during pauses in the transmission of data.

By means of the transmitter/receiver module 14 it is also possible to transmit data to the steering wheel and receive it there via the transmitter/receiver module 13. Such data may be, for example, triggering signals for an airbag or check data for checking the first transmission module 11 and/or the operator control elements 18 which are connected thereto. Furthermore, the steering wheel 10 may have playback elements for visually playing back data which is also transmitted in the way described.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Apparatus for wireless transmission of electrical signals between a movable portion of a vehicle steering wheel and a fixed region of the vehicle, said apparatus comprising:
a first transmission module which includes a first microcontroller and a transmitter for electromagnetic waves and is arranged on the movable portion of the steering wheel; and
a second transmission module which includes a second microcontroller and a receiver, and is arranged on the fixed region of the vehicle; wherein,
the second microcontroller is configured to convert signals received in the receiver into signals for controlling electrical devices of the vehicle; and
a frequency of the electromagnetic waves between the transmission modules is in the gigahertz range;
the first microcontroller is configured to condition and convert electrical signals of switching or control elements arranged on the steering wheel into signals which are suitable for the transmitter;
an inductive transformer with downstream rectifier arrangement is also provided on the steering wheel to supply power to the first transmission module;
the inductive transformer has a first, fixed, annular winding and a second, concentric annular winding which can rotate with the steering wheel; and
an alternating voltage or clock frequency generator which is operated by direct current is connected upstream of the inductive transformer.

2. The apparatus as claimed in claim 1, wherein each of the transmitter and the receiver comprises a bidirectional transmitter/receiver device.

3. The apparatus as claimed in claim 1, wherein the transmitter and the receiver are embodied as Bluetooth modules.

4. The apparatus as claimed in claim 1, wherein the transmission modules are provided with bidirectional serial interfaces.

5. The apparatus as claimed in claim 4, wherein the serial interfaces are RS-232 interfaces.

6. The apparatus as claimed in claim 1, wherein the second annular winding is secured to a steering column of the steering wheel.

7. The apparatus as claimed in claim 1, wherein, to supply power to the first transmission module, a rectifier arrangement is provided which converts the received radio frequency energy at least partially and/or temporarily into a supply direct voltage; and
a storage device is provided in the form of one of a capacitor and an accumulator battery.
